(19) United States
(12) Patent Application Publication
(10) Pub. No.: US 2026/0102225 A1
(43) Pub. Date: Apr. 16, 2026

(54) ORTHODONTIC MEASURING DEVICE

(71) Applicant: Satya Nayak, Honolulu, HI (US)

(72) Inventor: Satya Nayak, Honolulu, HI (US)

(21) Appl. No.: 18/913,768

(22) Filed: Oct. 11, 2024

(51) Int. Cl. A61C 7/14

(52) U.S. Cl. CPC A61C 7/146

(57) ABSTRACT

An orthodontic measuring device. The device includes an elongated handle, a first horizontal arm portion extending from a first end of the handle, and a second horizontal arm portion extending from an opposite end of the handle. The first and second horizontal arm portions lie along a first axis. A first vertical gauge member affixed to the first horizontal arm portion extends upward from an upper planar surface of the first horizontal arm portion along a second axis. A second vertical gauge member affixed to the first horizontal arm portion extends downward from a lower horizontal planar surface of the first horizontal arm portion along the second axis. A third vertical gauge member affixed to the second horizontal arm portion extends upward from an upper planar surface of the second horizontal arm portion along a third axis. A fourth vertical gauge member affixed to the second horizontal arm portion extends downward from a lower horizontal planar surface of the second horizontal arm portion along the third axis.

### TECHNICAL FIELD

The present disclosure generally relates to an orthodontic device, and more specifically, to a device used to aid in the accurate placement of braces onto the teeth of an orthodontic patient.

### BACKGROUND

Orthodontic braces work by exerting constant pressure on a person's teeth and jaws to gently shift their position over time. A dentist or orthodontist first bonds or glues a bracket on each tooth, then place a thin, flexible archwire over the brackets, which applies pressure on teeth. As the archwire is incrementally tightened over time, the teeth move into a desired position, altering the soft tissue surrounding the teeth and bone, called the periodontal ligaments.

Measurement gauges are presently used to position the brackets on the teeth by making linear measurements from the incisal edges or cusp tips of the anterior (front) and posterior (back) teeth on the labial (lip) or buccal (cheek) side of the individual teeth toward the gingival (gums). Due to the anatomic variation in the height of cusps of posterior teeth, random wear patterns, and occasional cusp fractures, this method setting the bracket on the teeth has numerous shortcomings in accuracy.

Ideally, the orthodontist wants to position the brackets on all teeth so that the marginal ridges of the posterior teeth (the biting surface peripheral ridges located on the interproximal or side of the tooth) line up next to adjacent teeth in height. The marginal ridges should line up with little or no individual tooth marginal ridge variation in height to achieve the correct position of both upper and lower posterior teeth in order to allow opposing teeth to fit together when a person bites (or occludes) their teeth together.

The brackets on the posterior teeth should initially be positioned on each tooth so that when the archwire (bent in the shape of an upper or lower dental arch of teeth) is engaged in the brackets, the teeth being adjusted will eventually be ideally aligned one to the other in either an upper or lower dental arch; and when the opposing teeth are brought together in a neutral bite, they occlude (fit together) ideally.

FIGS. 1 and 2 depict a prior art measuring gauge 10 used to position brackets 30 on the teeth 40 of an orthodontic patient. As shown, the measuring gauge 10 may include a handle 12 and a distal end 14 having a center prong 16, a top prong 18, and a bottom prong 20. The gauge 10 is designed to allow orthodontics to measure the position of the bracket from the incisal edges or cusp tips of the teeth to a desired location along the facial surface of the tooth.

As shown, the center prong 16 is adapted to engage an edge or cusp tip of a tooth, while the top prong 18 is designed to be positioned along the center line of the braces bracket 30. Using the gauge 10, it is intended to position the brackets 30 at the same desired height along the anterior and posterior teeth. Depending on the size of the patient's teeth, the brackets 30 may be positioned at different distances from the incisal edges or cusp tips of the teeth.

For most prior art measuring gauges 10, the distance between the top prong 18 and the center prong 16 differs from the distance between the center prong 16 and the bottom prong 20. For instance, the distance between the top prong and the center prong 16 may be 4.5 mm, while the distance between the center prong 16 and the bottom prong 20 may be 4.0 mm. Thus, if the orthodontist wants to position the center of the bracket 4.0 mm from the edge or cusp tip of a tooth, then the orthodontist may flip or rotate the gauge 10 to use the bottom prong 20 as the reference prong to position the bracket.

While existing measuring gauges are useful in establishing uniform bracket placement along the upper and lower teeth, these gauges lack components ensuring that the gauges are consistently applied to the patient's teeth, causing what is called “parallax effect.” For example, if the gauge 10 is used at a slight angle relative to the teeth, as shown in FIG. 1, the bracket placement in FIG. 1 may be different than the bracket placement shown in FIG. 2, because gauge 10 is applied to the teeth at different relative angles. If the brackets are not uniformly positioned on the teeth, this may ultimately result in bracket bond failure and/or uneven tensioning along the teeth, which would affect the effectiveness of alignment and straightening of the teeth.

A need therefore exists for an accurate and easy-to-use gauge for assisting in the placement of brackets and other attachments on the teeth of orthodontic patients.

### SUMMARY

The present disclosure provides a gauge that enables orthodontists to quickly and accurately place braces brackets on the teeth of an orthodontic patients in the ideal occluso-gingival position. The gauge includes an elongated handle. A first horizontal arm portion extends from a first end of the handle, where the first horizontal arm portion lies along a first axis. A second horizontal arm portion extends from an opposite end of the handle, where the second horizontal arm portion lies along the first axis.

A first vertical gauge member affixed to the first horizontal arm portion extends upward from an upper planar surface of the first horizontal arm portion along a second axis. A second vertical gauge member affixed to the first horizontal arm portion extends downward from a lower horizontal planar surface of the first horizontal arm portion along the second axis. A third vertical gauge member affixed to the second horizontal arm portion extends upward from an upper planar surface of the second horizontal arm portion along a third axis. A fourth vertical gauge member affixed to the second horizontal arm portion extends downward from a lower horizontal planar surface of the second horizontal arm portion along the third axis.

The first and second horizontal arm portions each comprise planar surfaces adapted to abut the incisor edges or cusps edges of a patient's teeth when the gauge is applied to the patient's tooth. Each vertical gauge member includes an outward surface adapted to rest against the front of the clinical crown of the patient's tooth when the gauge is applied to the patient's teeth. In use, a vertical gauge member supports a bracket in a desired position on the patient's tooth.

The disclosure herein is a summary of the invention and not an extensive overview of all contemplated embodiments. It should be appreciated that many other features, applications, embodiments, implementations and/or variations of the disclosed technology will be apparent from the accompanying drawings and from the following detailed description. While multiple implementations are disclosed, the drawings and detailed description are to be regarded as illustrative in nature and not restrictive.

### BRIEF DESCRIPTION OF THE DRAWINGS

This disclosure may be better understood by referring to the following figures. The components in the figures are not necessarily to scale, emphasis instead being placed upon illustrating the principles of the disclosure. In the figures, the reference numerals designate corresponding parts throughout the different views.

FIG. 1 is a perspective view showing a prior art measuring gauge applied to a quadrant of a patient's teeth.

FIG. 2 is another perspective view showing a prior art measuring gauge applied to a quadrant of a patient's teeth.

FIG. 3 is a perspective view showing an embodiment of a measuring gauge of the present disclosure applied to a quadrant of a patient's teeth.

FIG. 4 is a side view of the measuring gauge of FIG. 3.

FIG. 5 is a top view of the measuring gauge of FIG. 3.

FIG. 6 is a side partial cross-section view of the measuring gauge of FIG. 3 applied to an incisor.

FIG. 7A is a front plan view of a patient's mouth showing upper anterior teeth with brackets mounted to the teeth and an archwire segment.

FIG. 7B is another front plan view of a patient's mouth showing upper anterior teeth with brackets mounted to the teeth and an archwire segment.

FIG. 8 is a top view showing the lower teeth of a patient with brackets mounted to the teeth and an archwire segment.

FIG. 9 is a side view showing a second embodiment of a measuring gauge of the present disclosure.

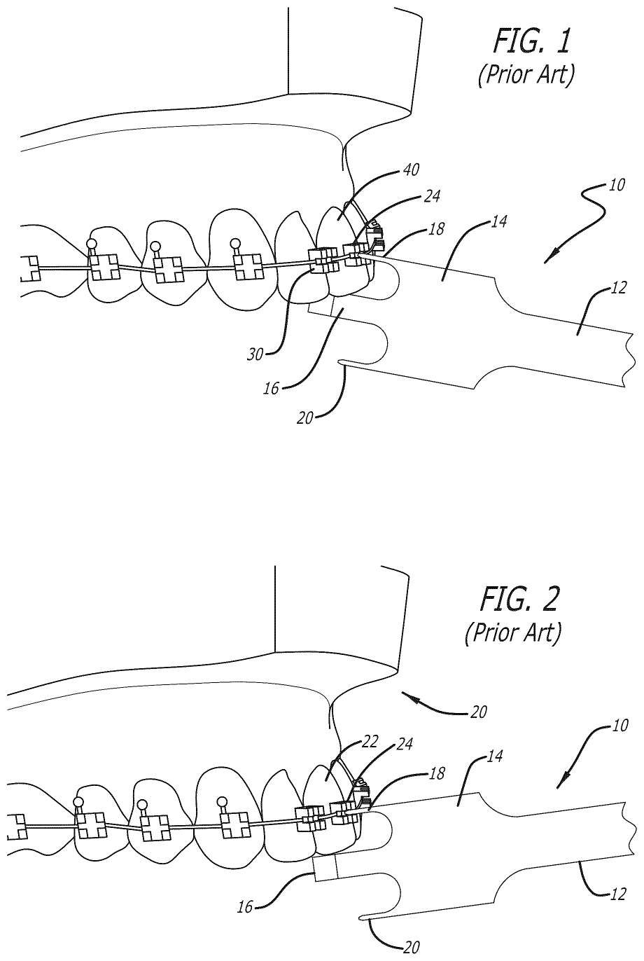

### DETAILED DESCRIPTION

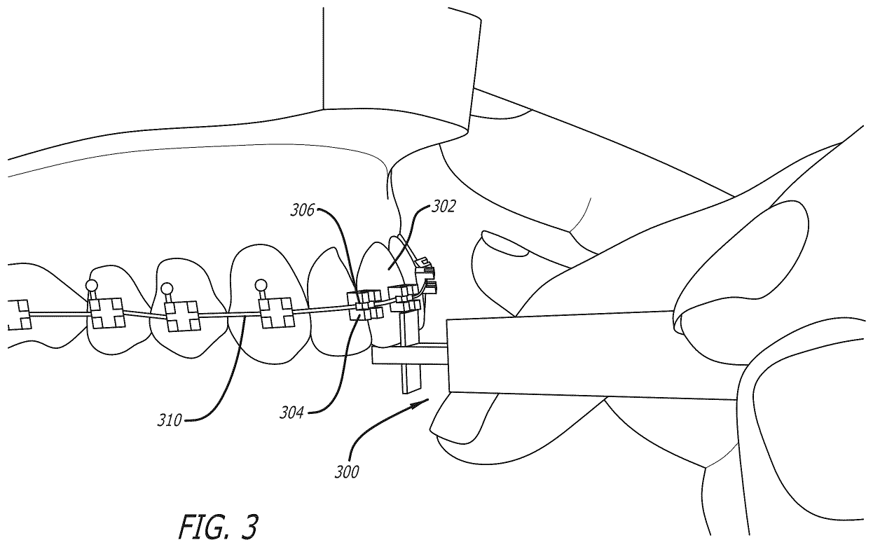

FIGS. 3-9 illustrate examples of various implementations of an orthodontic measuring device. As described herein, the device includes an elongated handle, a first horizontal arm portion extending from a first end of the handle, and a second horizontal arm portion extending from an opposite end of the handle. The first and second horizontal arm portions lie along a first axis.

A first vertical gauge member affixed to the first horizontal arm portion extends upward from an upper planar surface of the first horizontal arm portion along a second axis. A second vertical gauge member affixed to the first horizontal arm portion extends downward from a lower horizontal planar surface of the first horizontal arm portion along the second axis. A third vertical gauge member affixed to the second horizontal arm portion extends upward from an upper planar surface of the second horizontal arm portion along a third axis. A fourth vertical gauge member affixed to the second horizontal arm portion extends downward from a lower horizontal planar surface of the second horizontal arm portion along the third axis.

The first and second horizontal arm portions each comprise planar surfaces adapted to abut the incisor edges or cusps edges of a patient's teeth when the gauge is applied to the patient's teeth. Each vertical gauge member includes an outward surface adapted to rest against the front surface of the clinical crown of the patient's tooth when the gauge is applied to the patient's teeth. In use, a vertical gauge member supports a bracket at a desired position on the patient's tooth.

FIG. 3 is a perspective view of a measuring gauge 300 according to the teachings of the present disclosure applied to a quadrant of a patient's teeth 302. As shown, the measuring gauge 300 may be used to position one or more brackets 304 on the patient's teeth 302. A segment of an archwire 310 is shown positioned in slots 306 of the brackets 304. In this figure, the teeth's 302 incisal edges and cusp tips are shown.

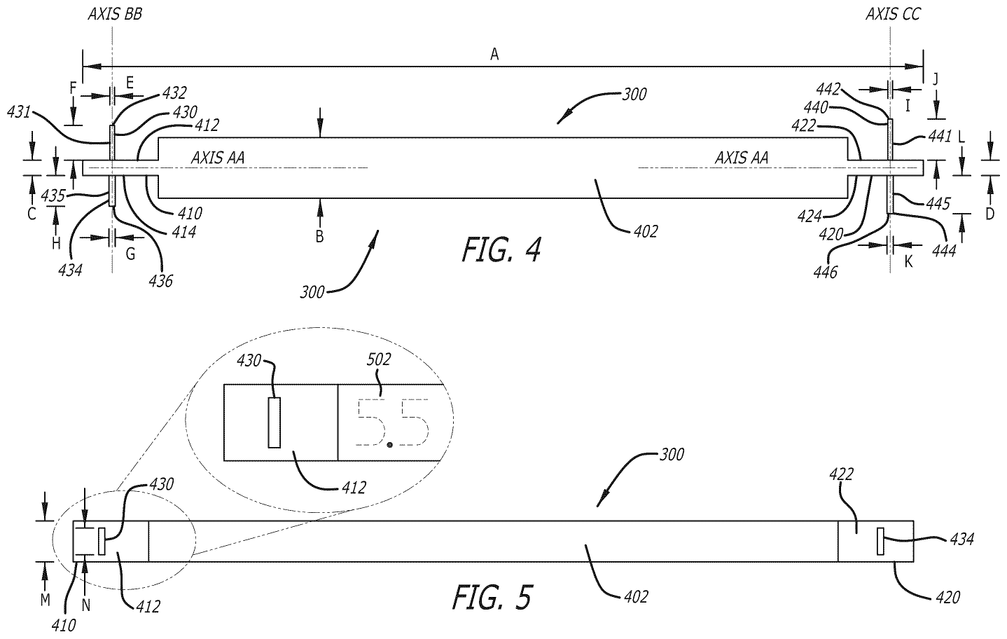

FIG. 4 is a side view of measuring gauge 300. As shown, the measuring gauge 300 may include a handle 402, a first horizontal arm portion 410 extending from one end of the handle 402, and a second horizontal arm portion 420 extending from an opposite end of the handle 402.

The handle 402 may comprise body 404 having an elongated rectangular bar construction with height B and width M (FIG. 5) dimensions. In some embodiments, the body 404 may be constructed to a height of 9 mm and width of 4.5 mm. However, the body 404 may be constructed to any suitable height and width dimensions. The handle 402 is constructed to enable the user to grip and generally handle the measuring gauge 300 during use.

Both the first horizontal arm portion 410 and the second horizontal arm portion 420 may comprise a substantially planar construction having a thickness C and D, respectively. In some embodiments, the horizontal arm portions 410 and 420 may be constructed to a thickness of about 2.0 mm, or any other suitable thickness. The first and second horizontal arm portions 410 and 420 further define a first axis (Axis A-A), extending therethrough. Each component of the measuring gauge 300 may be made of stainless steel, aluminum, titanium, nickel alloy, copper, ceramic, PVC, plastic, or any other suitable non-corrosive material. In some implementations, the measuring gauge 300 may be constructed to an overall length A of about 110 mm, or to any other suitable length.

The first horizontal arm portion may further comprise an upper planar surface 412 and a lower planar surface 414. The second horizontal arm portion may further comprise an upper planar surface 422 and a lower planar surface 424.

A first vertical gauge member 430 is affixed to the first horizontal arm portion 410. The first vertical gauge member 430 is constructed to extend upward from planar surface 412 along a second axis (Axis B-B), which is preferably generally at a right angle to Axis AA. The vertical gauge member 430 may comprise a slender plate construction having a thickness E and a height F. In some embodiments, gauge member 430 may be constructed to a thickness of about 0.6 mm, or any other suitable thickness.

The first vertical gauge member 430 may further include an outward-facing bearing surface 431 adapted to rest against the marginal ridge of a tooth. The first vertical gauge member 430 may also include an upper bearing surface 432 for supporting a bracket 304 as it is mounted onto a patient's tooth 302.

A second vertical gauge member 434 is also affixed to the first horizontal arm portion 410. The second vertical gauge member 434 is constructed to extend downward from planar surface 414 along Axis BB. The vertical gauge member 434 may comprise a slender plate construction having a thickness G and a height H. In some embodiments, gauge member 434 may be constructed to a thickness of about 0.6 mm, or any other suitable thickness.

The second vertical gauge member 434 may further include an outward-facing bearing surface 435 adapted to rest against the marginal ridge of a tooth. The second vertical gauge member 434 may also include a lower bearing surface 436 for supporting a bracket 304 as it is mounted onto a pateint's tooth 302.

Turning now to the opposite end of the handle 402, a third vertical gauge member 440 is affixed to the second horizontal arm portion 420. The third vertical gauge member 440 is constructed to extend upward from planar surface 422 along a third axis (Axis CC), which is preferably generally at a right angle to Axis AA. The vertical gauge member 440 may comprise a slender plate construction having a thickness I and a height J. In some embodiments, gauge member 440 may be constructed to a thickness of about 0.6 mm, or any other suitable thickness.

The third vertical gauge member 440 may further include an outward-facing bearing surface 441 adapted to rest against the marginal ridge of a tooth. The third vertical gauge member 440 may also include an upper bearing surface 442 for supporting a bracket 304 as it is mounted onto a patient's tooth 302.

A fourth vertical gauge member 444 is also affixed to the second horizontal arm portion 420. The fourth vertical gauge member 444 is constructed to extend downward from planar surface 424 along Axis CC. The vertical gauge member 444 may comprise a slender plate construction having a thickness K and a height L. In some embodiments, gauge member 446 may be constructed to a thickness of about 0.6 mm, or any other suitable thickness.

The fourth vertical gauge member 444 may further include an outward-facing bearing surface 445 adapted to rest against the marginal ridge of a tooth. The fourth vertical gauge member 444 may also include a lower bearing surface 446 for supporting a bracket 304 as it is mounted onto a patient's tooth 302.

FIG. 5 is a top view of measuring gauge 300. As shown, the planar surfaces 412, 414, 422, and 424 of the first and second horizontal arm portions 410 and 420 may comprise rectangular constructions. However, in other implementations, the planar surfaces 412, 414, 422, and 424 of the first and second horizontal arm portions 410 and 420 may comprise other suitable geometric shapes. In preferred embodiments, the width M of the first and second horizontal arm portions 410 and 420 correspond to the width of the handle 402. As also shown, in certain embodiments, the width N of each vertical gauge member 430, 434, 440, 444, may be shorter than the width of the first and second horizontal arm portions 410 and 420.

In some embodiments, the handle 402 may further include markings 502 on top and bottom planar surfaces of the handle near each of its ends to indicate the height dimensions of the corresponding vertical gauge member. For example, the marking 502 may comprise the alphanumeric lettering “5.5” to indicate to the user that the height of the corresponding vertical gauge member is 5.5 millimeters. This enables the user to quickly determine the range of bracket height settings for the applicable measuring gauge 300. The marking 502 may be stamped, embossed, etched, or inscribed on each end of the handle 402.

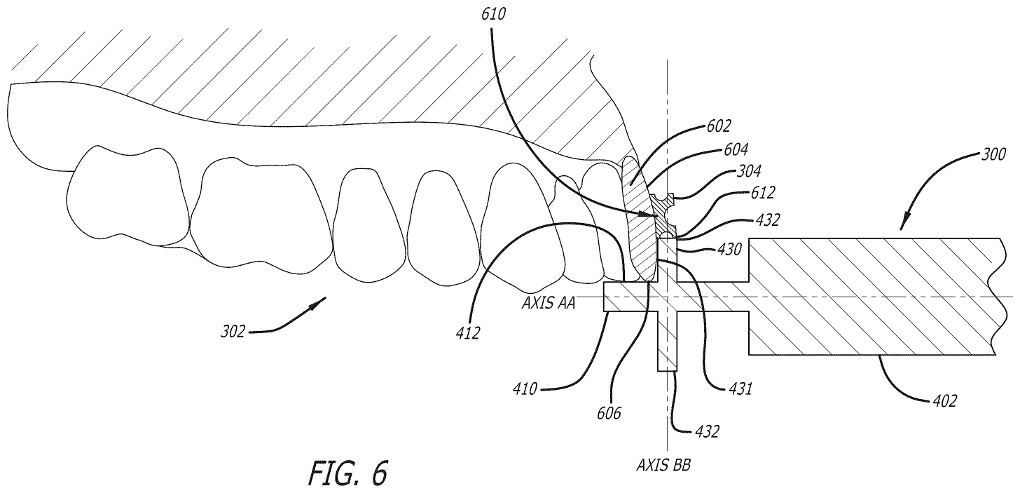

The use of the gauge 300 is best described with reference to FIG. 6. First, the operator must determine on a selected tooth, where the bracket should be ideally positioned. As shown, the measuring gauge 300 may be applied to a patient's tooth 602, for example, a central incisor. The gauge 300 may engage the tooth 602 such that the outward-facing bearing surface 431 of the first vertical gauge member 430 contacts and rests substantially flush against the facial surface of the crown of the tooth 602, while the upper planar surface 412 abuts the incisal edge 606 of the tooth 602. Accordingly, Axis AA may be positioned at a right angle or substantially right angle to a long axis of the tooth 602, with Axis BB of vertical gauge member being parallel or substantially parallel thereto. As such, the first vertical gauge member 430 the first horizontal arm portion 410 define a seat 606 for receiving and supporting the crown of the tooth 602 as the bracket 304 is bonded to the tooth 602.

Once the measuring gauge 300 is applied to the tooth 602 at the correct height for the attachments to be placed, an adhesive may be applied to a bonding surface 610 of the bracket 304 before the bracket is positioned on a facial surface 604 of the crown of a tooth 602, such that a bottom edge 612 of the bracket engages the upper bearing surface 432 of the first vertical gauge member 430. The adhesive may preferably be made of a sticky substance to enable the bracket 304 to slide along the tooth so the orthodontist may adjust the bracket 304 to a desired position before setting. In some embodiments, an orthodontist may initially engage the bracket 304 with the tooth 602 at a position slightly lower than the desired position, so once the bonding surface 610 of the bracket 304 is fully engaged with the facial surface 604 of the tooth 602, the orthodontist can adjust the bracket 304 up to the desired position.

Once the bracket 304 is adjusted to the desired tooth position, the gauge member 430 is adapted to secure the bracket 304 on the tooth 602 while the orthodontist uses an ultraviolet (UV) light or “blue light” to cure the adhesive and set the bracket 304 at the desired position on the tooth 602.

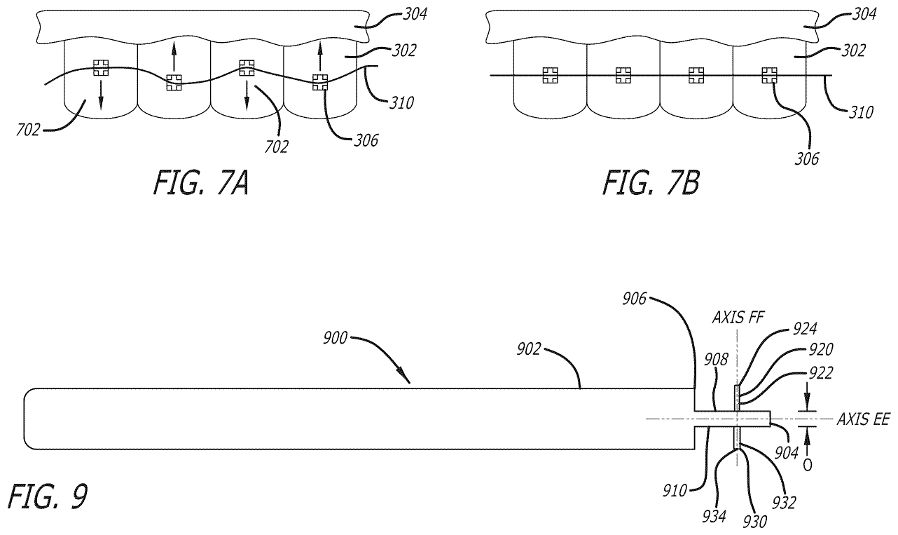

Existing measuring gauges often provide uneven bracket positioning along a patient's dental arcade, as shown in FIG. 7A. When brackets are not properly mounted along the dental arch, this generates shearing forces 702 on the brackets 306 as the archwire is tightened, resulting in bracket bond failures. Bracket bond failure is a common problem in orthodontics. In most cases, patients experienced bracket failures in the first month of the treatment. Most bracket bond failures occur in the lower dental arch.

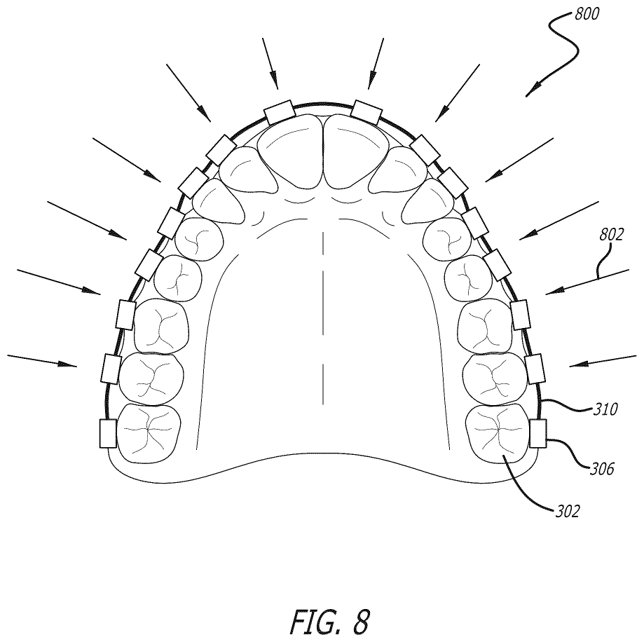

Uneven bracket placement may also cause misalignment of the patient's teeth, resulting in improper mesial rotation and uneven incisal edges and gingival levels because uneven hoop forces 802 (FIG. 8) will be applied to the teeth and jawline as the archwire is tightened, resulting in uneven shifting and misalignment of the teeth.

To the contrary, measuring gauges according to the teachings of the present disclosure provide even bracket placement across a patient's dental arcade, as shown in FIG. 7B. This generates even shearing forces 702 on the brackets 306 as the archwire is tightened, resulting in even teeth shifting and alignment. It also minimizes bracket failure. Measuring gauges of the present disclosure facilitate rapid attachment of the brackets to the patient's teeth.

In preferred embodiments, the height F of the first vertical gauge member 430 is different than the height H of the second vertical gauge member 434, the height J of the third vertical gauge member 440, and the height L of the fourth vertical gauge member 444. For example, in an implementation, the height F may be 4.0 mm, height H may be 4.5 mm, height J may be 5.0 mm, and height L may be 5.5 mm. As such, the user may engage whichever vertical gauge member providing the desired bracket location along the patient's teeth. For example, if the user desires to position the bottom of the bracket 4.5 mm from the cusp tip of the tooth, then the user would adapt the handle 402 to use the second vertical gauge member 434 to mount the bracket 304 onto the tooth 302. Accordingly, a single gauge device may be used to set the position of a bracket at one of four different height positions.

FIG. 8 is a plan view of the patient's upper jaw 800. As shown, the brackets 306 are mounted onto the teeth 302 and the archwire 30 is installed on the brackets 306. When the brackets 306 are installed on the 302 using measuring gauges of the present disclosure, hoop stress forces 802 are evenly applied to the teeth 302.

FIG. 9 is a side view of another exemplary embodiment of a measuring gauge 900 in accordance with the teachings of the present disclosure. As shown, the measuring gauge 900 may include a handle 902 and a horizontal arm portion 904 extending from a distal end 906 of the handle 402. In this example, the horizontal arm portion 904 may comprise a substantially planar construction having a thickness O. In some embodiments, the horizontal arm portion 904 may be constructed to a thickness of about 2 mm, or any other suitable thickness. The horizontal arm portion 904 further defines a first axis (Axis EE), extending therethrough. Each component of the measuring gauge 900 may be made of stainless steel, aluminum, titanium, nickel alloy, copper, ceramic, PVC, plastic, or any other suitable non-corrosive material.

The horizontal arm portion 904 may further comprise an upper planar surface 908 and a lower planar surface 910. A first vertical gauge member 920 is affixed to the horizontal arm portion 904, where the first vertical gauge member 920 extends upward from planar surface 910 along a second axis (Axis FF), which is preferably generally at a right angle to the horizontal arm portion 904 and Axis EE. The first vertical gauge member 920 may comprise a slender plate construction having a desired thickness and height.

The first vertical gauge member 920 may further include an outward facing bearing surface 922 adapted to rest against the facial surface of the tooth. The first vertical gauge member 420 may also include an upper bearing surface 424 for supporting a bracket 304 as it is positioned for mounting onto a pateint's tooth 302.

A second vertical gauge member 930 is affixed to the horizontal arm portion 904, where the second vertical gauge member 930 extends downward from planar surface 910 along Axis FF. The vertical gauge member 930 may comprise a slender plate construction having a desired thickness and height.

The second vertical gauge member 930 may further include an outward-facing bearing surface 932 adapted to rest against the marginal ridge of a tooth. The second vertical gauge member 4930 may also include a lower bearing surface 934 for supporting a bracket 304 as it is positioned for mounting onto a pateint's tooth 302.

In this example, the height of the first vertical gauge member 920 is different than the height of the second vertical gauge member 930. For example, the height of the first vertical gauge member 920 may be 4.0 mm, and the height of the second vertical gauge member 930 may be 4.5 mm. As such, an orthodontist may engage whichever vertical gauge member providing the desired bracket location along the patient's teeth. For example, if the user desires to position the bottom of the bracket 4.5 mm from the cusp tip of the tooth, then the user would adapt the handle 402 to use second vertical gauge member 434 to mount the bracket 304 on the tooth 302. Accordingly, this gauge may be used to position the brackets on a patient's teeth at one of two different height positions.

In this example, the gauge 900 may be applied and operated in a fashion similar to that of measuring gauge 900.

In general, terms such as “coupled to,” and “configured for coupling to,” and “secured to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

Although the previous description illustrates particular examples of various implementations, the present disclosure is not limited to the foregoing illustrative examples. A person skilled in the art is aware that the disclosure as defined by the appended claims and their equivalents can be applied in various further implementations and modifications. In particular, a combination of the various features of the described implementations is possible, as far as these features are not in contradiction with each other. Accordingly, the foregoing description of implementations has been presented for purposes of illustration and description. Modifications and variations are possible in light of the above description.

What is claimed is:

1. A measurement gauge for placement of attachments for orthodontic braces, comprising:
an elongated handle having a first axis;
a first horizontal arm portion extending from a first end of the handle, the first horizontal arm portion lying on the first axis and having a first edge;
a second horizontal arm portion extending from an opposite end of the handle, the second horizontal arm portion lying on the first axis and having a second edge;
a first vertical gauge member affixed to the first horizontal arm portion, the first vertical gauge member extending upward from an upper planar surface of the first horizontal arm portion along a second axis, where the second axis is offset from the first edge and substantially perpendicular to the first axis;
a second vertical gauge member affixed to the first horizontal arm portion, the second vertical gauge member extending downward from a lower horizontal planar surface of the first horizontal arm portion along the second axis;
a third vertical gauge member affixed to the second horizontal arm portion, the third vertical gauge member extending upward from an upper planar surface of the second horizontal arm portion along a third axis, where the third axis is offset from the second edge and substantially perpendicular to the first axis; and
a fourth vertical gauge member affixed to the second horizontal arm portion, the fourth vertical gauge member extending downward from a lower horizontal planar surface of the second horizontal arm portion along the third axis.

2. The measurement gauge of claim 1, wherein the first, second, third, and fourth vertical gauge members each extend outward from the first horizontal arm portion and the second horizontal arm portion, respectively, to a certain height dimension.

3. The measurement gauge of claim 1, wherein each vertical gauge member comprises an outward facing bearing surface adapted to engage a facial surface of the tooth.

4. The measurement gauge of claim 3, wherein each vertical gauge member comprises an upper bearing surface adapted to support a lower portion of the bracket.

5. The measurement gauge of claim 4, wherein the first horizontal arm portion and the first vertical gauge member define a seat for receiving and supporting the crown of the tooth.

6. The measurement gauge of claim 4, wherein the first horizontal arm portion and the second vertical gauge member define a seat for receiving and supporting the crown of the tooth.

7. The measurement gauge of claim 4, wherein the second horizontal arm portion and the third vertical gauge member define a seat for receiving and supporting the crown of the tooth.

8. The measurement gauge of claim 4, wherein the second horizontal arm portion and the fourth vertical gauge member define a seat for receiving and supporting the crown of the tooth.

9. The measurement gauge of claim 2, wherein the first, second, third, and fourth vertical gauge members each have different height dimensions.

10. A measurement gauge for placement of attachments for orthodontic braces, comprising:
an elongated handle;
a horizontal arm portion extending from a distal end of the handle, the horizontal arm portion lying on a first axis;
a first vertical gauge member affixed to the horizontal arm portion, the first vertical gauge member extending upward from an upper planar surface of the horizontal arm portion along a second axis; and
a second vertical gauge member affixed to the horizontal arm portion, the second vertical gauge member extending downward from a lower horizontal planar surface of the horizontal arm portion along the second axis.

11. The measurement gauge of claim 10, wherein the first and second vertical gauge members extend outward from the horizontal arm portion to a certain height dimension.

12. The measurement gauge of claim 10, wherein each vertical gauge member comprises an outward facing bearing surface adapted to engage a facial surface of the tooth.

13. The measurement gauge of claim 12, wherein each vertical gauge member comprises an upper bearing surface adapted to support a lower portion of the bracket.

14. The measurement gauge of claim 13, wherein the horizontal arm portion and the first vertical gauge member define a seat for receiving and supporting the crown of the tooth.

15. The measurement gauge of claim 13, wherein the horizontal arm portion and the second vertical gauge member define a seat for receiving and supporting the crown of the tooth.

16. The measurement gauge of claim 11, wherein the first, second, third, and fourth vertical gauge members each have different height dimensions.
